(19) United States
(12) Patent Application Publication
(10) Pub. No.: US 2026/0068000 A1
(43) Pub. Date: Mar. 5, 2026

(54) PRINTED RESISTIVE HEATER

(71) Applicant: VECTOR ELECTRONICS Sp. z o.o., Torun (PL)

(72) Inventors: Daniel JANCZAK, Torun (PL); Jerzy KOMOSINSKI, Torun (PL); Damian MATEWSKI, Torun (PL); Robert SOTKIEWICZ, Torun (PL)

(21) Appl. No.: 19/312,436

(22) Filed: Aug. 28, 2025

(30) Foreign Application Priority Data
Aug. 28, 2024 (PL) P.449600

(51) Int. Cl. H05B 3/36; B41M 1/12; B41M 1/30; B41M 3/00; B41M 7/00; C09D 11/033; C09D 11/037; C09D 11/52; H05B 3/14

(52) U.S. Cl. CPC H05B 3/36; B41M 1/12; B41M 1/30; B41M 3/008; B41M 7/0027; C09D 11/033; C09D 11/037; C09D 11/52; H05B 3/145; H05B 2203/003; H05B 2203/016; H05B 2203/017

(57) ABSTRACT

A printed resistive heater has a flexible plastic substrate; a resistive heating layer applied on the substrate; and conductive bus electrodes electrically connected to opposite sides of the heating layer. The heating layer and the bus electrodes are formed by a printing process from ink or paste.

### TECHNICAL FIELD

The present invention relates to a printed resistive heater, that is particularly suitable for printed electronics manufacturing processes, such as screen printing.

### BACKGROUND

Resistive heaters are known in the art and have been implemented in various devices for providing localized heating. Such heaters are typically produced using conventional fabrication techniques on rigid substrates.

With the development of printed electronics, interest has arisen in producing functional components, including heaters, by printing processes such as screen printing. This allows integration of heating elements with other printed circuit components.

However, difficulties are encountered when attempting to form heaters on flexible plastic substrates. These substrates are generally limited in their ability to withstand the relatively high processing temperatures often required during manufacture of electronic circuits. As a result, known heater structures and methods are not always suitable for reliable use with such substrates.

There is therefore a continuing need for printed resistive heater structures which can be applied on flexible plastic substrates in a reliable and efficient manner.

### SUMMARY OF THE INVENTION

One aspect of the invention provides a printed resistive heater comprising a flexible plastic substrate, a resistive heating layer applied on the substrate, and conductive bus electrodes electrically connected to opposite sides of the heating layer, wherein both the heating layer and the bus electrodes are formed by a printing process from ink or paste. This allows cost-efficient manufacturing of heaters on flexible substrates using printed electronics methods, enabling integration into lightweight and bendable devices.

In a preferred embodiment, the flexible plastic substrate is a polymer film selected from polyethylene terephthalate (PET), polyethylene (PE), or combined PET/PE, having a thickness of 50-500 μm.

In another preferred embodiment, the resistive heating layer has a rectangular surface, with bus electrodes extending along opposite sides of the rectangle.

In a further preferred embodiment, the resistive heating layer is formed as a serpentine trace, with bus electrodes extending along opposite edges of the serpentine.

In another preferred embodiment, the heater further comprises an electrically insulating layer disposed over the resistive heating layer.

In a more specific embodiment, the electrically insulating layer comprises a UV-curable dielectric ink or an additional polymer film.

In yet another preferred embodiment, the resistive heating layer is formed from a resistive composition comprising a mixture of flake graphite and conductive carbon black. The resistive composition may comprise 60-90 wt % of a vehicle and 10-40 wt % of a filler, the filler being a mixture of flake graphite and conductive carbon black, wherein the vehicle comprises 89-95 wt % of at least one solvent selected from α-terpineol, butyl diglycol acetate (BDGA), dibutyl phthalate (DBP), ethanol, and ethylene glycol, and 5-11 wt % of at least one binder selected from polymethyl methacrylate (PMMA), polyvinylidene fluoride (PVDF), polyurethane (PU), styrene-butadiene-styrene (SBS), and ethyl cellulose (EC).

In another preferred embodiment, the bus electrodes are formed from a conductive composition comprising silver flakes. The conductive composition may comprise 10-50 wt % of a vehicle and 50-90 wt % of a filler, the filler being silver flakes, wherein the vehicle comprises 89-95 w t% of at least one solvent selected from α-terpineol, butyl diglycol acetate (BDGA), dibutyl phthalate (DBP), ethanol, and ethylene glycol, and 5-11 wt % of at least one binder selected from polymethyl methacrylate (PMMA), polyvinylidene fluoride (PVDF), polyurethane (PU), styrene-butadiene-styrene (SBS), and ethyl cellulose (EC).

Another aspect of the invention relates to a method of manufacturing a printed resistive heater, the method comprising: providing a flexible plastic substrate; printing, onto the substrate, a resistive heating layer from a resistive ink or paste; and printing conductive bus electrodes from a conductive ink or paste so that each bus electrode is in electrical contact with an opposite side of the resistive heating layer.

These and other features, aspects and advantages of the invention will become better understood with reference to the following drawings, descriptions and claims.

### BRIEF DESCRIPTION OF THE DRAWINGS

The subject matter of the invention is illustrated by means of example embodiments in the accompanying drawings, in which:

FIG. 1A shows a schematic top view of the heater in a first embodiment.

FIG. 1B shows a schematic cross-sectional view along line A-A of the first embodiment.

FIG. 2A shows a schematic top view of the heater in a second embodiment.

FIG. 2B shows a schematic cross-sectional view along line A-A of the second embodiment.

FIG. 3A shows a schematic top view of the heater in a third embodiment.

FIG. 3B shows a schematic cross-sectional view along line A-A of the third embodiment.

FIG. 4A shows a schematic top view of the heater in a fourth embodiment.

FIG. 4B shows a schematic cross-sectional view along line A-A of the fourth embodiment.

FIG. 5 shows a schematic top view of the heater in a fifth embodiment.

### DETAILED DESCRIPTION

The invention is further illustrated below by way of exemplary embodiments. The description is not to be taken in a limiting sense, but is made merely for the purpose of illustrating the general principles of the invention.

The heaters can be manufactured on various types of flexible plastic substrates 1, such as polymer films. Suitable examples include polyethylene terephthalate (PET) or polyethylene (PE) OR combined PET/PE films with a thickness in the range of 50 to 500 μm.

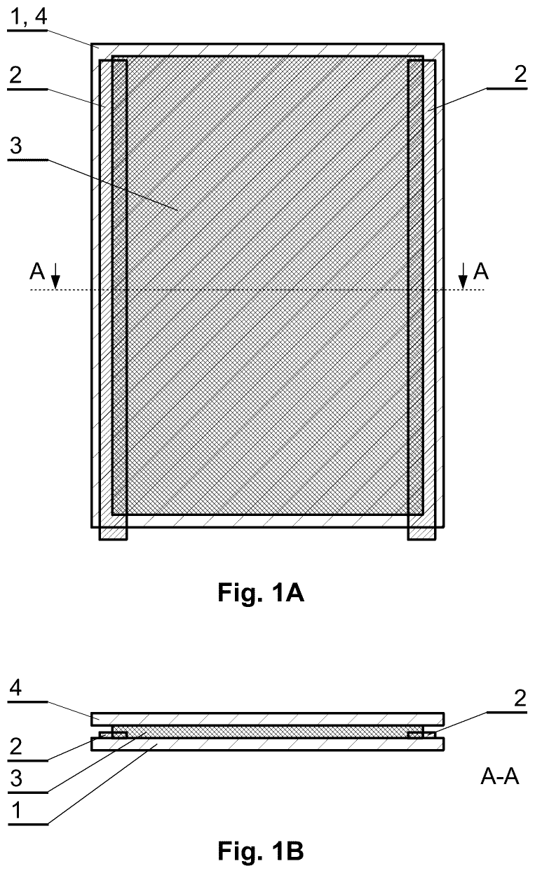

In the first embodiment, shown in FIGS. 1A and 1B, conductive bus electrodes 2 and a resistive heating layer 3 are successively applied onto the substrate 1. Both layers 2 and 3 are deposited using a printed electronics manufacturing process, such as screen printing. The resistive heating layer 3 has a rectangular shape. The conductive bus electrodes 2 extend along opposite sides of the element forming the heating layer 3, in locations through which current flows to generate heat.

An electrically insulating layer 4, for example a UV-curable dielectric ink or an additional PET film, is applied over the heating layer 3. The electrically insulating layer 4 provides electrical insulation from the environment and mechanical protection, for instance against scratches. Other curable dielectric coatings or electrically non-conductive flexible sheets may also be used.

According to the invention, the heaters are printed using inks or pastes with rapid curing times, enabling continuous production in a roll-to-roll process.

The conductive bus electrodes 2 are formed from a conductive ink or paste containing silver flakes. Preferably, the conductive composition comprises 10-50 wt % of the vehicle (more preferably 20-30 wt %) and 50-90 wt % of the silver flakes filler (more preferably 70-80 wt %). The silver flakes preferably have a particle size in the range of 0.5 to 2 μm.

The resistive heating layer 3 is formed from a resistive ink or paste based on a mixture of flake graphite and conductive carbon black. Preferably, the resistive composition comprises 60-90 wt % of the vehicle (more preferably 70-80 wt %) and 10-40 wt % of the filler (more preferably 20-30 wt %). The filler is a mixture of flake graphite and conductive carbon black, preferably sieved to particle sizes in the range of 50-500 μm.

In both the conductive and resistive compositions, the vehicle comprises at least one solvent and at least one binder (resin). The solvent content is 89-95 wt % of the vehicle and the solvent may be selected from α-terpineol, butyl diglycol acetate (BDGA), dibutyl phthalate (DBP), ethanol, or ethylene glycol. The binder content is 5-11 wt % of the vehicle and the binder may be selected from polymethyl methacrylate (PMMA), polyvinylidene fluoride (PVDF), polyurethane (PU), styrene-butadiene-styrene (SBS), or ethyl cellulose (EC). Preferably, the mixture of flake graphite and conductive carbon black contains less than 5 wt % of carbon black.

In a preferred formulation, the vehicle solvent contains 50-82 wt % of BDGA, 9-10 wt % of DBP, and optionally up to 31 wt % of α-terpineol, with ethyl cellulose (EC) as the binder in an amount of 5-11 wt %. In a more specific embodiment, the vehicle consists of 82 wt % of BDGA, 9 wt % of DBP, and 9 wt % of EC, percentages being by weight of the vehicle.

Heaters produced in this way are capable of operating at supply voltages between 6 and 48 V and at temperatures up to 100° C.

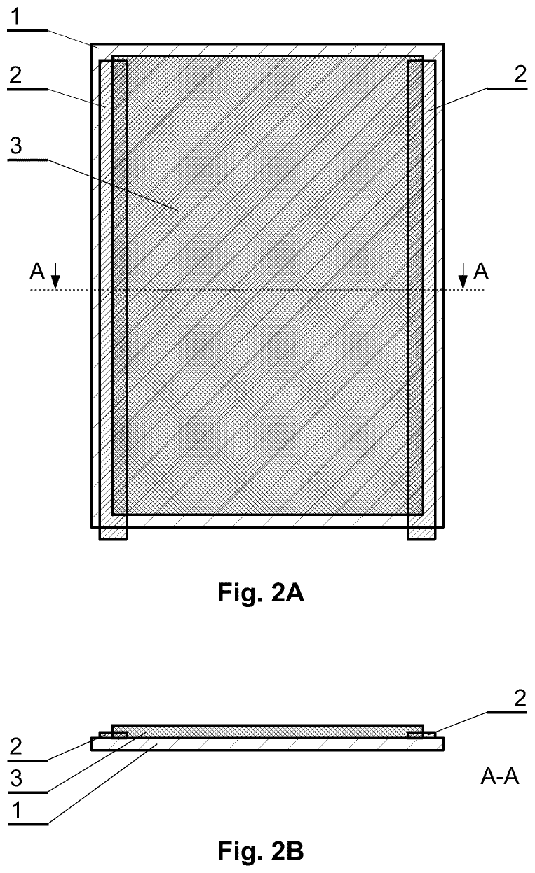

FIGS. 2A and 2B illustrate a second embodiment, which differs from the first in that it does not include an electrically insulating layer 4. Such heaters may be particularly suitable as semi-finished products for systems that will subsequently be enclosed within a protective housing together with other components.

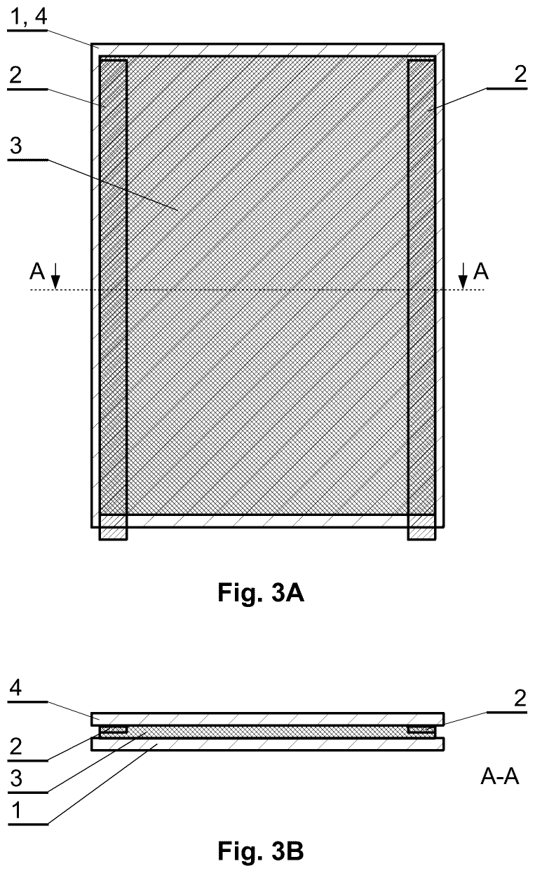

FIGS. 3A and 3B illustrate a third embodiment, in which the order of application differs: the resistive heating layer 3 is applied first, followed by the conductive bus electrodes 2 on the substrate 1.

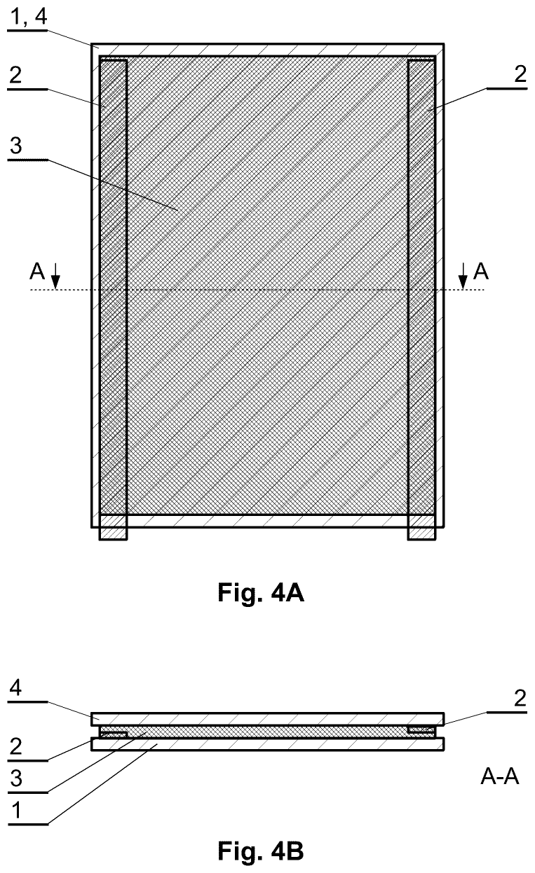

FIGS. 4A and 4B illustrate a fourth embodiment, in which a first conductive bus electrode is applied directly onto the substrate 1, while the second conductive bus electrode is applied on top of the resistive heating layer 3.

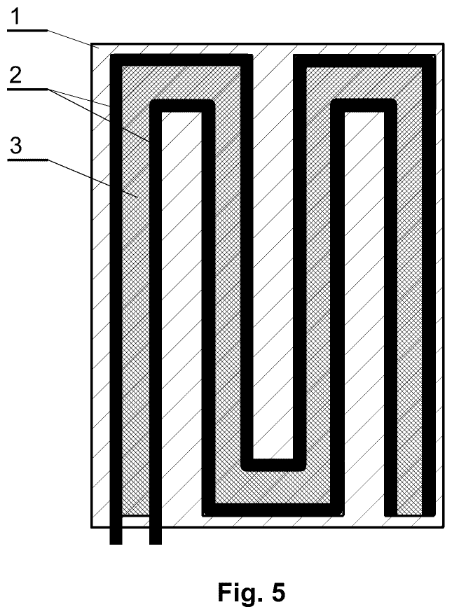

FIG. 5 illustrates a fifth embodiment, where the resistive heating layer 3 is patterned as a serpentine (meander) trace on the substrate 1, with conductive bus electrodes 2 arranged along the edges thereof. Such serpentine or other patterned shapes can be used to control and optimize the heating surface distribution.

While the invention has been described with respect to a limited number of embodiments, it will be appreciated that many variations, modifications and other applications of the invention may be made. Therefore, the claimed invention as recited in the claims that follow is not limited to the embodiments described herein.

1. A printed resistive heater, comprising:
a flexible plastic substrate;
a resistive heating layer applied on the substrate; and
conductive bus electrodes electrically connected to opposite sides of the heating layer;
wherein the heating layer and the bus electrodes are formed by a printing process from ink or paste.

2. The heater of claim 1, wherein the flexible plastic substrate is a polymer film selected from polyethylene terephthalate (PET), polyethylene (PE), or combined PET/PE, having a thickness of 50-500 μm.

3. The heater of claim 1, wherein the resistive heating layer has a rectangular surface, and the bus electrodes extend along opposite sides of the rectangle.

4. The heater of claim 1, wherein the resistive heating layer comprises a serpentine trace, and the bus electrodes extend along opposite edges of the serpentine.

5. The heater of claim 1, further comprising an electrically insulating layer disposed over the resistive heating layer.

6. The heater of claim 5, wherein the electrically insulating layer comprises a UV-curable dielectric ink or an additional polymer film.

7. The heater of claim 1, wherein the resistive heating layer is formed from a resistive composition comprising a mixture of flake graphite and conductive carbon black.

8. The heater of claim 7, wherein the resistive composition comprises:
60-90 wt % of a vehicle, preferably 70-80 wt %; and
10-40 wt % of a filler, preferably 20-30 wt %,
the filler comprising a mixture of flake graphite and conductive carbon black,
and the vehicle comprising 89-95 wt % of at least one solvent selected from α-terpineol,
butyl diglycol acetate (BDGA), dibutyl phthalate (DBP), ethanol, and ethylene glycol, and 5-11 wt % of at least one binder selected from polymethyl methacrylate (PMMA), polyvinylidene fluoride (PVDF), polyurethane (PU), styrene-butadiene-styrene (SBS), and ethyl cellulose (EC).

9. The heater of claim 1, wherein the bus electrodes are formed from a conductive composition comprising silver flakes.

10. The heater of claim 9, wherein the conductive composition comprises:
10-50 wt % of a vehicle, preferably 20-30 wt %; and
50-90 wt % of a filler, preferably 70-80 wt %,
the filler being silver flakes,
and the vehicle comprising 89-95 wt % of at least one solvent selected from α-terpineol, butyl diglycol acetate (BDGA), dibutyl phthalate (DBP), ethanol, and ethylene glycol, and 5-11 wt % of at least one binder selected from polymethyl methacrylate (PMMA), polyvinylidene fluoride (PVDF), polyurethane (PU), styrene-butadiene-styrene (SBS), and ethyl cellulose (EC).

11. A method of manufacturing a printed resistive heater, the method comprising:
providing a flexible plastic substrate;
printing, onto the substrate, a resistive heating layer from a resistive ink or paste; and
printing conductive bus electrodes from a conductive ink or paste so that each bus electrode is in electrical contact with an opposite side of the resistive heating layer.

12. The method of claim 11, wherein the printing steps are carried out by screen printing.

13. The method of claim 11, further comprising printing or laminating an electrically insulating layer over the resistive heating layer.

14. The method of claim 11, wherein printing the resistive heating layer precedes printing the conductive bus electrodes.

15. The method of claim 11, wherein printing the conductive bus electrodes precedes printing the resistive heating layer.
